(19) United States
(12) Patent Application Publication
(10) Pub. No.: US 2023/0185263 A1
(43) Pub. Date: Jun. 15, 2023

(54) SYSTEM, METHOD, AND COMPUTER PROGRAM PRODUCT FOR HIERARCHICAL HOME CONTROL

(71) Applicant: Veev Group, Inc., San Mateo, CA (US)

(72) Inventors: Alon KLEIN, Herzliya (IL); Binyamin GIL, Rehovot (IL); Ira Seth KUGELMAN, Kiryat Ono (IL); Ariel COHEN, Holon (IL); Amit HALLER, Belmont, CA (US)

(21) Appl. No.: 18/066,454

(22) Filed: Dec. 15, 2022

Related U.S. Application Data
(60) Provisional application No. 63/289,903, filed on Dec. 15, 2021.

(51) Int. Cl. G05B 19/042

(52) U.S. Cl. CPC G05B 19/042; G05B 2219/2642

(57) ABSTRACT

A smart home system comprising a data repository defining categories or groupings of smart home appliances or devices, and storing, for each individual appliance, an indication of a controller which governs the individual appliance; a user interface which may present a menu of the categories and which may enable a smart home end-user to enter a selection of a command and an individual category from among the categories to which the command is to be applied; and a hardware processor which, responsive to the selection, retrieves from the data repository the indication of the controller which governs each appliance in the individual category, to define a set of controllers to which the command is to be communicated, and communicates the command to all controllers in the set.

### REFERENCE TO CO-PENDING APPLICATIONS

Priority is claimed from U.S. Provisional Patent Application No. 63/289,903 entitled “Hierarchical home control system” which was filed on Dec. 15, 2021, the disclosure of which application is hereby incorporated herein by reference.

### FIELD OF THIS DISCLOSURE

The present invention relates generally to construction, and more particularly to construction of homes.

### BACKGROUND FOR THIS DISCLOSURE

A state-of-the-art construction approach is presented here: ‘Tesla of homes’: Can a construction tech company solve the housing shortage by building homes faster? (yahoo.com).

Articles available online e.g. The average person doesn't have a chance with the smart home|TechCrunch, published on TechCrunch on 18 Feb. 2022, describe how “the smart home has failed”. The author of this reference laments that “actually making a smart home that works in harmony is a nightmare that the average person is unlikely to be able to navigate on their own”. He confides that he “researched devices for weeks . . . when setting up our new home, ultimately settling on a set of brands that . . . I knew . . . worked with Google Home, Amazon Alexa and Apple's HomeKit platform.” The author advocates Matter, which is touted as “One protocol to connect compatible devices and systems with one another” although “companies are still working on adding support for the standard, which will take time—and there's no guarantee manufacturers will bother updating existing devices . . . . That means for the foreseeable future, the smart home remains . . . confusing for most people . . . . Until . . . a standard like Matter solves the integration hole so . . . nobody needs . . . “Raspberry Pi” to make things harmonious, I won't be recommending my parents invest in smart lights”.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide a hierarchical home control system with an integrated communication network and energy (e.g., electrical) network. The hierarchical system typically integrates the networking aspects of both energy and control e.g. the network for carrying data and control signals is either the same as the energy distribution network (the same infrastructure, e.g. the same wiring and controllers, serve both purposes), or the two purposes are at least coupled, since some portions of the network, e.g. some wiring, certain cables, certain controllers, are shared for dual use.

Certain embodiments of the present invention seek to provide infrastructure for supporting a smart home which includes a power/energy supply arrangement which supports devices which do not require high power, obviating transformers. Energy distribution may wholly or partially coincide with the control network.

Smart home systems typically comprise add-on components (e.g., added to an existing, already-built physical home) which utilize an existing electrical and communications network. In a typical housing environment, these components are of different vendor origins, employing different design guidelines and use different user interfacing techniques, forcing the end user to adapt to multiple platform solutions. In addition, existing, all-in-one, control solutions, cannot truly manage any device from any vendor in a harmonious way, and, in many cases, a declared “supported device” does not necessarily mean that the full broad functionality of the device itself may be actually handled by the system, nor it can effectively serve complex operational scenarios. In many cases, the communications protocols (e.g. as defined by e Z-Wave or Zigbee standards or by Apple's Homekit standard) and the electrical requirements of such devices do not perfectly match the existing house infrastructure, forcing a compromised use.

According to certain embodiments, designing a smart home includes determining which appliances, if any, require intervention. For example, a conventional dishwasher appliance requires AC power and its electrical outlet may be controlled ON/OFF. Any additional functions which the dishwasher is to include, are provided as part of the building/home infrastructure, when the house is designed and built, rather than afterwards, by suitably configuring the device abstract and intelligence layer for the dishwasher, and similarly for any other device/appliance.

In addition, in many housing arrangements, the case of multiple tenants is not limited to a single house or apartment. Apartment buildings, for example, typically include common areas which are shared or used by tenants from different apartments or houses. This further complicates home control scenarios.

In cases where the home control system is a fully integrated system, many of the above-described disadvantages remain true, as the integration part is mostly evident in the user interfacing functions, but the communication and electrical networks remain nearly untouched. While the advantage of a managed service is typically offered with the system, the infrastructure limitations persist. For example, a device which requires specific power arrangements (e.g., voltage waveform and levels) may require a physical adapter to maintain its functionality. For example, LED lights operate at a low voltage, yet the domestic electrical network is high voltage (110/220V AC) hence a dedicated transformer and power adapter may be required e.g., integrated into the LED light source, or separately provided. It may be advantageous to enable the energy distribution network to distribute low voltage power supply for all LED lights within the house.

The end result is that end-user behavior is significantly preoccupied with struggling to adapt to the disadvantages and limitations of such systems.

According to certain embodiments, relational databases are provided to store metadata describing rooms and appliances. This allows commands to be applied to, say, “all window shades in master bedrooms which face south” in a project with a multiplicity of living units. According to certain embodiments, this command would be applied to all window shades in a set of rooms which is an intersection between a stored indication of all master bedrooms and a stored indication of all rooms facing south.

According to certain embodiments, a top application, layer is provided, which directly receives, from end-users, instructions to turn on and off and otherwise operate smart home appliances which may be described in natural language. A bottom infrastructure layer includes hardware for physically controlling the appliances. Then, intermediate layers may include device layers, typically including both a device intelligence layer and a device abstraction layer, and a home intelligence layer. The home intelligence layer may include data repository defining categories or groupings of smart home appliances or devices, and storing, for each individual appliance, an indication of a controller which governs the individual appliance, and/or a user interface presenting a menu of the categories and enabling a smart home end-user to enter a selection of a command and an individual category from among the categories to which the command is to be applied, and/or a processor which, responsive to the selection, retrieves from the data repository the indication of the controller which governs each appliance in the individual category, thereby to define a set of controllers to which the command is to be communicated, and communicates the command to all controllers in the set.

According to certain embodiments, the device layers are responsible (typically responsive to changing conditions e.g., as sensed) for providing certain appliances with their power supply at a dynamic higher or lower voltage, even though a power line with a fixed given voltage, e.g., 12V, is actually physically powering the appliances. Typically, as part of designing the smart home, appliance operating algorithms are developed to yield any desired function of the device. For example, if an appliance is intended to provide controllable window shading, an operating algorithm for the appliance (e.g. window shade) may be designed for specifically adjusting shading levels by sending appropriate control signals to the involved components and applying a power supply as needed. Thus, intelligent layer/s herein may be responsible for implementing an algorithm for supplying power to a given appliance responsive to inputs via the appliance layer and/or responsive to sensed conditions e.g., temperature or humidity. For example, according to a certain algorithm for supplying power to a certain appliance's motor, which may be stored in memory, an appliance's motor may, having been turned on, initially be driven at an escalating amount of wattage (to prevent suddenly bringing the motor to a high voltage). The high wattage, once achieved, is useful to overcome inertia of the currently stationary motor, which may, once target motor RPM has been achieved, be driven at lower wattage.

It is appreciated that an operating algorithm may be configured to ensure that a certain degree of illumination is provided by utilizing natural daylight (e.g. shades being less than completely closed), but this may be coupled with other functions, such as cooling the house in the summer time, hence a shading operation may depend on the time of day as well as on the specifics of the day (e.g. a cloudy day or hotter day) to decrease/increase the shading for regulating the sun heating effect on the house itself. For example, the operating algorithm may, at a certain point, be configured to provide maximum shading and turn on electrical lights, but reduce the load on the HVAC system, as there is no need to mitigate additional heat building up through sun radiation from the windows.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1. A smart home system comprising:

a data repository typically defining categories or groupings of smart home appliances or devices, and/or storing, e.g. for each individual appliance, an indication of a controller which governs the individual appliance; and/or

a user interface typically presenting a menu of the categories and/or enabling a smart home end-user to enter a selection of a command and/or an individual category e.g. from among the categories to which the command is to be applied; and

a hardware processor which may, e.g. responsive to the selection, retrieve from the data repository the indication of the controller which governs each appliance in the individual category, which defines a set of controllers to which the command is to be communicated, and/or communicates the command to controllers e.g. to all controllers in the set.

Embodiment 2. A system according to any of the preceding embodiments wherein the data repository comprises at least one relational database thereby to support plural orthogonal groupings of the appliances.

Embodiment 3. A system according to any of the preceding embodiments wherein the plural groupings are along at least one of the following dimensions: functionality of the appliance, architectural unit in which the appliance is deployed (room, living unit, story/floor, building), geographical location of the appliance, physical characteristics of the appliance such as energy requirements, or appliance age.

Embodiment 4. A system according to any of the preceding embodiments wherein the data repository comprises tables storing groupings of appliances and indications of which controllers govern which appliances.

Embodiment 5. A system according to any of the preceding embodiments wherein the categories include a first category of appliances facing in a first geographical direction, and a second category of appliances facing in a second geographical direction.

Embodiment 6. A system according to any of the preceding embodiments wherein the appliances comprise at least one of window shades, light fixtures, and HVAC (heating, ventilation and air-conditioning) devices.

Embodiment 7. A system according to any of the preceding embodiments wherein the categories includes a first category of appliances deployed in a first room, and a second category of appliances deployed in a second room.

Embodiment 8. A system according to any of the preceding embodiments wherein the categories includes a first category of appliances deployed on a first floor, or story, or level, and a second category of appliances deployed in a second floor, or story, or level.

Embodiment 9. A system according to any of the preceding embodiments wherein the categories includes a first category of appliances having a first functionality such as HVAC devices, and a second category of appliances having a second functionality, such as light fixtures.

Embodiment 10. A system according to any of the preceding embodiments wherein the smart home appliances serve a condominium including plural living units, and wherein the categories includes a first category of appliances deployed in a first subset of the plural living units, and a second category of appliances deployed in a second subset of the plural living units.

Embodiment 11. A system according to any of the preceding embodiments and also comprising wireless communication functionality to enable the end-user to enter the selection from a remote location.

Embodiment 12. A smart house system comprising:

an infrastructure layer including a physical network which provides communication with, and power distribution to, appliances, the physical network including controllers which give commands, aka control signals, to appliances, aka devices;

an application layer above the infrastructure layer which provides protocols that allow end-user software to send data to at least one layer below, and to receive data from the at least one layer below, and to present the data so received to end-users;

a home intelligence layer below the application layer which communicates commands, selected by end-users, to controllers which govern the appliances; and

at least one device layer, between the home intelligence layer and the infrastructure layer, which generates interpretations of commands communicated by the home intelligence layer, and wherein the interpretations depend on at least one device parameter.

Embodiment 13. A system according to any of the preceding embodiments wherein data sent down from the application layer is at end-user level such as “no shading”, “partial shading”, or “full shading”, and wherein the at least one device layer translates the data at end-user level to data understandable by at least one appliance.

Embodiment 14. A system according to any of the preceding embodiments wherein at least one device layer translates data at end-user level to commands directed to specific controller output ports which cause at least one appliance motor to operate in specific respective modes.

Embodiment 15. A system according to any of the preceding embodiments wherein hardware and/or software in each individual layer communicate with hardware and/or software in adjacent layers just below or just above the individual layer, thereby to define a stack of layers.

Embodiment 16. A system according to any of the preceding embodiments wherein hardware and/or software in each individual layer communicate only with the hardware or software in adjacent layers just below and/or just above the individual layer, and do not communicate with hardware and with software which are deployed in non-adjacent layers which are not just below the individual layer and are not just above the individual layer.

Embodiment 17. A system according to any of the preceding embodiments wherein each layer comprises logic implemented in hardware and/or firmware and/or software.

Embodiment 18. A system according to any of the preceding embodiments wherein the home intelligence layer comprises a data repository defining categories or groupings of smart home appliances or devices, and storing, for each individual appliance, an indication of a controller which governs the individual appliance; a user interface (presenting a menu of the categories) enabling a smart home end-user to enter a selection of a command and an individual category from among the categories to which the command is to be applied; and a processor which, responsive to the selection, retrieves from the data repository the indication of the controller which governs each appliance in the individual category, thereby to define a set of controllers to which the command is to be communicated, and communicates the command to all controllers in the set.

It is appreciated that the home intelligence layer is typically implemented in both software and hardware.

Embodiment 19. A system according to any of the preceding embodiments wherein the at least one device layer includes a device intelligence layer and a device abstraction layer just below the device intelligence layer, wherein the device intelligence layer defines appliance settings which configure the appliance's ability to serve the end-user.

Embodiment 20. A system according to any of the preceding embodiments wherein the device abstraction layer defines power and control parameters which govern supply of power to, and control of, the appliances.

Embodiment 21. A system according to any of the preceding embodiments wherein the device abstraction layer governs the appliances' connectivity for purposes of receiving communication from and/or control of each appliance aka device.

The Device Abstraction layer typically determines all or any subset of the following regarding each device:
How the device is connected to the home control system
How many ports (of the control system) need to be allocated for controlling the device
What protocol/s is/are used to control each device and/or to receive communication back from the device
Will the device require power and if so what voltage and which type of power (AC/DC).

Thus a device abstraction layer typically does handle what is connected, power hook up, control ports, protocol for control and telemetry etc., and more generally, does handle connection, including control and communication but typically is unaware about the primary function of each device e.g. is unaware that the device is, say, a “Fan”, “LED light” or “Alarm system”.

In contrast, the Device intelligence layer is aware of device functionality provided by the device itself e.g. if the device is “LED light”, the Device intelligence layer is typically aware of “turn light on” “turn light off” and (e.g. if the device supports dimming and has controls which govern this type of function) also “dim light 25%”. Or, if the device is an HVAC device e.g. a Fan, the Device intelligence layer is typically aware of functionality, provided by the fan, which may, say, include “no-fan”, “weak fan power”, “mid fan power”, “max fan power”, “swivel right left on” and “swivel right left off”. The device intelligence layer is typically aware of temperature settings (if the device is an HVAC device e.g.) and if there is a need to change the temperature the device intelligence layer knows how to send a command “set temp to 26 degrees” by converting this command into appropriate signals communicated over the ports allocated for the device abstraction layer.

Embodiment 22. A system according to any of the preceding embodiments wherein the physical network includes at least one telemetry bus and wherein the device abstraction layer comprises a controller which receives at least commands for appliances from the device intelligence layer via an incoming command bus, and addresses each of which uniquely identifies one of the appliances, via an incoming address bus, and may also receive selections of a given controller from among plural controllers, if plural controllers exist, via an optional incoming select bus and which, responsively, generates telemetry data which is fed out via the telemetry bus.

Embodiment 23. A system according to any of the preceding embodiments wherein the device abstraction layer comprises resource management functionality.

Embodiment 24. A system according to any of the preceding embodiments wherein the device intelligence layer achieves a target value of a single sensed parameter by operating plural appliances which, together, bring the sensed parameter to the target value.

Embodiment 25. A system according to any of the preceding embodiments wherein at least one appliance has a motor which operates until a sensed parameter achieves a target value and wherein the device intelligence layer slows the motor as the sensed parameter approaches the target value.

Embodiment 26. A system according to any of the preceding embodiments wherein at least one appliance has plural control ports and wherein the device intelligence layer implements a schedule which selects various of the plural control ports in turn, so as to enable the appliance to serve the end-user.

Embodiment 27. A system according to any of the preceding embodiments and wherein the device intelligence layer determines a schedule of pulses provided to the control ports including scheduling at least one pulse with a first width and first duty cycle and, subsequently, at least one pulse with a second width which differs from the first width and/or with a second duty cycle which differs from the first duty cycle.

Embodiment 28. A system according to any of the preceding embodiments wherein a system health processor monitors system health, and wherein plural controllers are provided to yield redundancy and ensure operativity even when only some of the plural controllers are operational, and wherein the system health processor at least once turns off at least one non-operational controller and turns on at least one controller which has been standing by.

Embodiment 29. A system according to any of the preceding embodiments wherein the device intelligence layer turns at least one appliance on or off, given at least one condition such as a timing condition.

Embodiment 30. A system according to any of the preceding embodiments wherein the home intelligence layer has access to a stored representation of deployment of appliances per room and is configured to:

receive from the application layer at least one user command addressed to a recipient appliance identified by the application layer as “appliance x in room y”; and

to interpret the command for at least one layer below the home intelligence layer which is unaware of which appliance is deployed in which room, by identifying the recipient appliance in electrical layout terms understandable by the layer below, using the stored representation of deployment.

Embodiment 31. A system according to any of the preceding embodiments and wherein at least one of the application layer and the device intelligence layer is/are implemented in software.

Embodiment 32. A system according to any of the preceding embodiments and wherein the application layer includes at least one appliance-specific application which, upon transition from one mode to another mode selected by a user via an application, communicates with a configured set of appliances via the home intelligence layer, including adjusting at least one appliance-setting for all appliances in the configured set.

For example, an “Alarm System Application” may, responsive to activation of a privacy mode by an end-user via an application, communicate with all window shades via the home intelligence layer, including setting shading to maximum in all windows.

It is appreciated that the application layer may handle high level functions which orchestrate plural devices, which, together, support or provide a function requested by a user. Thus applications in the application layer may or may not be specific to a single appliance. For example, a climate control app may turn plural HVAC devices on/off, and/or may set a target temperature for plural HVAC related devices to yield an overall thermal comfort target which may be user-defined.

Embodiment 33. A system according to any of the preceding embodiments wherein the Device Intelligence layer is configured to turn at least one appliance on/off, via the device abstraction layer, responsive to a condition comprising a logical combination of sensed states.

An example of an “intelligent” function of a device being achieved via the device intelligence layer is that, for example, a light may automatically turn on or off, depending on some logical condition, such as but not limited to human presence, time-of-day, or a logical combination of both.

Embodiment 34. A smart home operating method comprising:

providing a data repository defining categories or groupings of smart home appliances or devices, and storing, for each individual appliance, an indication of a controller which governs the individual appliance;

providing a user interface enabling a smart home end-user to enter a selection of a command and an individual category from among the categories to which the command is to be applied; and

responsive to the selection, retrieving from the data repository the indication of the controller which governs each appliance in the individual category, thereby to define a set of controllers to which the command is to be communicated, and communicating the command to all controllers in the set.

Embodiment 35. A computer program product, comprising a non-transitory tangible computer readable medium having computer readable program code embodied therein, the computer readable program code adapted to be executed to implement a smart home operating method comprising:

providing a data repository defining categories or groupings of smart home appliances or devices, and storing, for each individual appliance, an indication of a controller which governs the individual appliance;

providing a user interface enabling a smart home end-user to enter a selection of a command and an individual category from among the categories to which the command is to be applied; and

responsive to the selection, retrieving from the data repository the indication of the controller which governs each appliance in the individual category, thereby to define a set of controllers to which the command is to be communicated, and communicating the command to all controllers in the set.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of at least one conventional personal computer processor, workstation, or other programmable device or computer or electronic computing device or processor, either general-purpose, or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of a server, a data processor, a memory/computer storage, a communication interface (wireless (e.g., BLE) or wired (e.g. USB)), or a computer program stored in memory/computer storage.

The term “process” as used above is intended to include any type of computation or manipulation or transformation of data represented as physical, e.g., electronic, phenomena which may occur or reside e.g., within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features, and functionalities of the invention shown and described herein.

Alternatively, or in addition, the apparatus of the present invention may include, according to certain embodiments of the invention, a program as above, which may be written in any conventional programming language, and optionally a machine for executing the program, such as but not limited to, a general purpose computer, which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols, and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g., computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein, which may, for example, include all or any subset of an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus, the term user interface or “UI” as used herein includes also the underlying logic which controls the data presented to the user e.g., by the system display and receives and processes and/or provides to other modules herein, data entered by a user e.g., using her or his workstation/device.

### BRIEF DESCRIPTION OF THE DRAWINGS

Certain embodiments of the present invention are illustrated in the following drawings; in the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language, or may comply with any conventional query language or protocol.

Specifically:

FIG. 1 illustrates a layered architecture of the system according to an embodiment.

FIG. 2 illustrates an Infrastructure layer including the integration of a communication network and electrical network according to an embodiment.

FIG. 3 illustrates a modified electrical network for control system use according to an embodiment; typically all or any subset of the layers in FIG. 1 are provided.

FIG. 4 illustrates a communication network example (hybrid of communication formats and devices) according to an embodiment; typically all or any subset of the layers in FIG. 1 are provided.

FIGS. 5a-5d present example network details and exemplify what an infrastructure layer may include; the outputs of the controllers in FIGS. 5a-5d, aka ports, may carry control signals and/or telemetry and/or can be to deliver power (e.g., PWM). Specifically,

FIG. 5A illustrates a controller example (bus architecture) according to an embodiment.

FIG. 5B illustrates a controller example with telemetry bus option (bi-directional communications) according to an embodiment.

FIG. 5C illustrates a parallel arrangement of multiple controllers according to an embodiment.

FIG. 5D illustrates a daisy chain arrangement of controllers (i.e., wired together in a sequence or ring) according to an embodiment and may be used in conjunction with the embodiment of FIG. 3.

FIG. 5E illustrates a Puke Width Modulated Power Supply and Control according to an embodiment and is an example of usefulness of a device abstraction layer, in this case for a device which requires PWM power control arrangement. An example of device intelligence layer operation is provided in FIGS. 6a-6c which demonstrate by way of example how a window shade may operate.

FIG. 6A illustrates a Window Shading Device Example (shading rolling down) according to an embodiment.

FIG. 6B illustrates a Window Shading Device Example (shading rolling up) according to an embodiment.

FIG. 6C illustrates plural PWM (Pulse Width Modulated) arrangements for adjusting motor torque and speed according to an embodiment.

FIGS. 7a-7c and 8 illustrate how a home intelligence layer may handle association of devices and devices' functions as related with house layout e.g. arrangements of rooms like bedroom/s, living room, kitchen, etc . . . specifically:

FIG. 7A illustrates a home intelligence layer—home map example—according to an embodiment.

FIG. 7B illustrates configuration tables demonstrating associations between rooms, devices and controllers, according to an embodiment.

FIG. 7C illustrates a configuration table presenting geographical data (window direction), according to an embodiment.

FIG. 8 illustrates a method for associating between geographical information and device location, according to an embodiment.

FIG. 9 illustrates example screenshots for applications utilizing the application layer, according to an embodiment.

FIG. 10 illustrates an alternative embodiment for the “application layer” including a meta application layer for handling multiple systems.

FIG. 11 is a home appliance power distribution table useful in understanding certain embodiments.

Methods and systems included in the scope of the present invention may include any subset or all of the functional blocks shown in the specifically illustrated implementations by way of example, in any suitable order e.g., as shown. Flows may include all or any subset of the illustrated operations, suitably ordered e.g., as shown. Tables herein may include all or any subset of the fields and/or records and/or cells and/or rows and/or columns described.

Computational, functional or logical components described and illustrated herein may be implemented in various forms, for example as hardware circuits, such as but not limited to custom VLSI circuits or gate arrays or programmable hardware devices, such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines, and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology), or any combination thereof.

Functionality or operations stipulated as being software-implemented may, alternatively, be wholly or fully implemented by an equivalent hardware or firmware module, and vice versa. Firmware implementing functionality described herein, if provided, may be held in any suitable memory device, and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC, or DSP, or any suitable combination thereof.

Any hardware component mentioned herein may in fact include either one or more hardware devices e.g., chips, which may be co-located or remote from one another.

Any method described herein is intended to include, within the scope of the embodiments of the present invention, also any software or computer program performing all or any subset of the method's operations, including a mobile application, platform, or operating system e.g. as stored in a medium, as well as combining the computer program with a hardware device to perform all or any subset of the operations of the method.

Data may be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include any apparatus which is primary, secondary, tertiary or off-line, which is of any type or level or amount or category of volatility, differentiation, mutability, accessibility, addressability, capacity, performance and energy use, and which is based on any suitable technologies such as semiconductor, magnetic, optical, paper, and others.

### DETAILED DESCRIPTION OF CERTAIN EMBODIMENTS

Smart home solutions are described herein which typically include providing a networking and power distribution infrastructure as described herein, as opposed for example, to relying on an already existing infrastructure which is inferior, for smart home purposes, to embodiments described herein. Power distribution control is typically not limited to on-off switching functionality and instead other power delivery characteristics may be provided (e.g., as voltage waveform changes) and the power distribution itself is typically coupled to networking functions e.g., as described herein.

Reference is now made to the drawings which are useful in understanding the following embodiments inter alia:

Embodiment a. A home control system comprising at least one home control logic layer, and at least one infrastructure network integrated with the home control layer.

Embodiment b. A system according to any of the preceding embodiments wherein the at least one infrastructure network comprises a communication network.

Embodiment c. A system according to any of the preceding embodiments wherein the at least one infrastructure network comprises an electrical network including an electrical power supply and wiring including power cables running from the electric power supply to plural appliances.

Embodiment d. A system according to any of the preceding embodiments wherein the electrical network comprises a main electrical and/or solar and/or other (typically AC) power line used to directly power higher power devices which is also, in parallel, transformed to DC levels appropriate for power distribution (e.g., 24V/48V lines) and each of the lines are used to feed different appliances.

Embodiment e. A system according to any of the preceding embodiments wherein at least one DC based powered device is fed through a PWM/IO (Pulse Width Modulated input/output) network which provides at least one direct connection and/or at least one relayed connection to the at least one DC based powered device, wherein at least one AC device is conditionally operated by a relayed connection whereby a relay is controlled to selectably connect and disconnect the AC device's power source.

Embodiment f. A system according to any of the preceding embodiments wherein the electrical network includes at least one PWM (Pulse Width Modulated) and/or IO device which are controlled and/or monitored by the communication network.

Embodiment g. A home providing method comprising constructing homes including installing a controller, and at least one infrastructure network integrated with the controller.

Embodiment h. A method according to any previous embodiment wherein at least one LED lighting fixture is provided which is responsive to an external control signal, and which, rather than being coupled to high voltage (e.g. 110/220V) electrical AC lines supplying electricity which are connected indirectly to the lighting fixture, via a wall switch which may turn the fixture on and off by selectably connecting and disconnecting the fixture to/from an electrical supply, is connected directly to the electrical supply which supplies DC at a lower voltage sufficient for LED fixtures, and is adapted to be responsive to an external control signal.

Embodiment i. A system according to any of the preceding embodiments wherein the electrical network includes appliances which are battery operated, hence reducing power supply requirements relative to appliances which are not battery operated, and wherein the controller directly supplies the appliances with reduced power supply, rather than supplying the appliances with a higher power supply, and then providing localized voltage transformation as the higher power supply reaches the appliance.

Embodiment j. A system according to any of the preceding embodiments wherein the application layer provides plural user interfaces to at least house occupant end-users and to service provider end-users, respectively.

Embodiment k. A system according to any of the preceding embodiments wherein the home control layer includes an application layer with logic configured for at least one of end-user applications and level L configuration and management applications.

Embodiment l. A home control system including plural home control systems, each including a home control system according to any of the preceding embodiments, and a meta-application layer with logic configured for configuration and management applications at a hierarchical level higher than level L, thereby to yield hierarchical control.

Embodiment m. A system according to any of the preceding embodiments and also comprising a device abstraction layer.

Embodiment n. A system according to any of the preceding embodiments and also comprising a device intelligence layer.

State-of-the-art home control paradigms are typically focused on providing add-on components and devices to an existing infrastructure. These solutions avoid imposing any electrical changes to an existing electrical network or to existing network communications. Even so-called “fully integrated” solutions may simply adapt to an existing infrastructure platform, even though the existing infrastructure is actually limiting functionality and control; such existing solutions typically focus on bypassing these limitations to some degree.

For example, a ceiling lighting fixture may require electrical wires supplying electricity (typically 110/220V AC). Traditionally, these wires are not connected directly to the lighting fixture; rather, they are actually connected first to a wall switch which may disconnect or connect the electrical supply (e.g., turn on/off) to the lighting fixture. A typical add-on solution for controlling the light may mostly focus on replacing the switch with a “smarter” version of it, while a better solution is to eliminate, up-front, the wiring to the wall switch, and adapt the lighting fixture to be responsive to an external control signal. In addition, running high voltage electrical AC lines to the lighting fixture is conventional, but if illumination relies at least partly on LED technology, the need for high voltage AC may at least partly be replaced by the need for lower voltage DC. Many other appliances in the home environment have become battery operated, hence reducing power supply requirements. Existing solutions may not even consider changing the electrical network, and may provide localized voltage transformation, adding complexity and reducing overall system reliability.

It is appreciated that LED appliances are referred to herein as an example of appliances which use low voltage e.g. lower voltage than other appliances such as 12 or 24 volts of power vs. higher voltage appliances using, say, over 50 volts of power, and/or lower than the household voltage or average amount of electrical power supplied to each outlet, which may be, depending inter alia on the country, 120 volts, or 220-240 volts. In conventionally wired homes, there may be one standard voltage for heavy-duty appliances, and another, lower level of voltage for all other appliances; alternatively, a single voltage may be provided for all appliances. In conventional household wiring, voltage is supplied through a single wire or cable that may carry 120 or 22 volts (say), and electricity travels through each plugged-in appliance, returning to a “neutral” wire in the outlet to enable the electric charge to travel back to ground, for neutralization, via a household circuit box. Sometimes, there is an alternating current design which may include two hot wires, and a third wire which is neutral. Sometimes, an appliance with high power requirements, such as an electric dryer, is connected to the main via wire that is thicker or larger in gauge than the wire which connects other appliances with lower power requirements. The lower-power appliances in the home may use one of plural e.g., two output phases on the home's transformer, whereas higher-power appliances may get power from plural phases. For example, a dryer's electrical sockets may provide first and second hot connections, connected to first and second phases on the transformer respectively.

It is appreciated that conventional LED fixtures are typically purchased with drivers which transform mains voltage from, say, 240v to the lower voltage required by the fixture, and also transform the mains voltage alternating current to the direct current (DC) that the LED fixtures use. However, according to embodiments herein, no such driver may be required.

As opposed to the state-of-the-art, in which (e.g. as indicated here: https://greenice.com/en/blog/what-transformer-do-i-need-for-the-installation-of-my-led-strips-n83, “for most customers it is very difficult to choose both the strip model that fits their needs and the transformer they need for them”, in the system herein the infrastructure typically supports low voltage, thus obviating any need to buy additional transformers for locally adapting high power to low power.

In another example, consider a popular smart water boiler switch which replaces a traditional switched timer. The functionality of the smart switch highly depends on the firmware (software) of the switch itself. Most of the vendors offering such devices allow for scheduled operation settings which basically means setting the days and hours of operation using some smart phone app. On the other hand, and as been seen in many cases, the end-user would also require just to turn the boiler on without the use of an app, yet, as the boiler is a high-power appliance, a countdown timer should be applied, limiting the operating time to some maximum duration (e.g., 30 minutes). This feature is, e.g. as indicated, typically missed by vendors, and the end-user is either forced to adapt its own behavior (e.g., remembering to turn it off using another timer) or, if technically savvy enough, use some external platforms which allow for programming smart home scenarios (e.g., IFTTT), yet this cannot be considered as a valid, reliable, and scalable solution for property management companies etc. addressing the needs of typical managed tenants and properties.

End-users may, for example, include home control system manufacturers, construction companies, property management companies, etc.

There may be at least two user types of such systems. From a house occupant perspective, this yields a hierarchal system with richer functionality, higher reliability, and simplified use relative to conventional systems, whereas from the maintenance and service-oriented end-users, the system is easier to maintain, upgrade, and add future components with a broad set of functions, relative to conventional systems.

The system and methods described herein may rely on the integration of a communication network infrastructure and an electrical network infrastructure. A layered, hierarchical, methodology is typically implemented for flexibility, reliability, efficiency, and ease of use and maintenance.

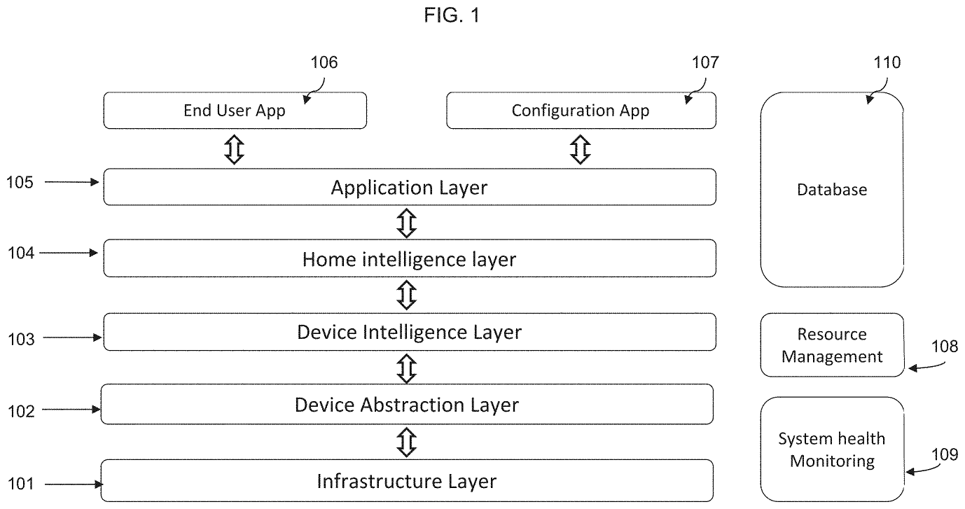

In FIG. 1 layered methodology is demonstrated; all or any subset of the illustrated layers may be provided. The infrastructure layer (101), typically the lowest layer, combines an electrical network and a communication network used by the home control system. A device deployed within the network uses a device abstraction layer (102) which describes the basic interfacing needs of the device (power, control), while the device intelligence layer (103) provides the logic, behavior, and functionality of such a device. The home intelligence layer (104) integrates the use of all the devices within the house (or apartment) and provides geographical related associations (e.g., bedroom, kitchen). The application layer (105) facilitates the use of various applications which utilize the home control system. This layer is logically divided into two types of applications—end-user applications (106) and configuration applications (107). The end-user apps are typically oriented for daily life activities of the tenant, while the configuration applications which may be used by home-owners to control daily house activities such as climate control, lighting on/off, alarm system on/off, are oriented for management and operation. For example, an application for controlling different lighting scenarios for the tenant may be included in an end-user app, while adding or deleting new devices into the network may be part of a configuration app's functionality.

It is appreciated that different layers are aware of different levels of information regarding appliances. Thus the abstraction layer may allocate ports per device with some designated functions (e.g. FIG. 1, element 108 may allocate ports) whereas higher layers are typically unaware of ports. For example, when “shut down fan @livingroom” is to be executed, the relevant higher layers are not aware which controller/ports are used. Conversely, abstraction layers which typically determine which ports are used and/or power delivery characteristics (e.g., AC, DC, voltage level, . . . ) and/or communication protocols are typically unaware of higher level function e.g. what the fan can do and where it is deployed.

Typically, each layer “needs to know” certain data. For example, at the top (application layer), it may be desired to provide a high level function through software applications (which run on a smart home processor (cloud or onsite central or at the controller level) such as “provide 50% shading to all windows facing south between sunrise to 11:00 am”, without the top layer being knowledgeable about where the windows are, how many windows, how the shades operate, which controller is connected to which window, what are the exact signals to be sent through the controllers to the shading motor, etc. The house intelligence layer provides knowledge of appliances/components types and locations (e.g. using databases and software interfaces for accessing the databases) but, as is the case for the application layer, the house intelligence layer does not need detailed knowledge regarding each device's operation. The device intelligence layer typically uses software-based algorithms which provide high level device functions by orchestrating lower level controls. The device abstraction layer provides software drivers with access to the low level functions of the device.

According to certain embodiments, the hardware or software in each layer only communicates with the hardware or software in the adjacent layers, and may not communicate with the hardware or software in non-adjacent layers. For example, layer 2 may communicate only with layers 1 and 3, and typically not with layers 4 and 5. Layer 5 may communicate only with layer 4, and so forth.

Typically, there are additional functions which may operate in the background, e.g., periodically or continually. A resource management function (108) is responsible for allocating resources to new devices, either statically or dynamically. Such resources may include specific memory or control bus addresses for identification and management purposes and/or electrical power allocation as part of a given energy budget. A system health monitoring function (109) is responsible for routinely checking the system's integrity. This may include, for example, pinging various devices for communication testing and/or measuring temperatures of energy supply units for identifying, in advance, possible failures (predictive maintenance). Dynamic master-slave allocations are typically made by function/s 108 and/or 109 e.g., when the system's management functionality senses appliance failures and, responsively, slave appliances are re-assigned to be masters.

A database (110) is provided, for storing various memory-oriented information such as configuration plans and/or short term and longer term data and statistics.

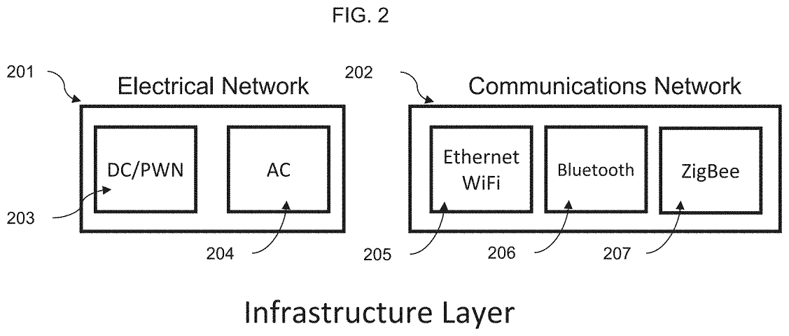

Regarding the infrastructure network (e.g., as shown in FIG. 2)—this layer typically provides integration between an electrical (201) and communications (202) network. The electrical network may include at least AC-driven (204) for supporting legacy high-power appliances in addition to DC, and a pulse width modulated (203) network for supporting low to mid power appliances. The sources of energy for this may be a national electrical grid/network, solar panels etc. The communications network is typically a hybrid of ethernet based, WiFi (205) Bluetooth (206) based or other low power networking platforms such as Zwave (207) or ZigBee (208) to accommodate a variety of different smart home components and their respective requirements.

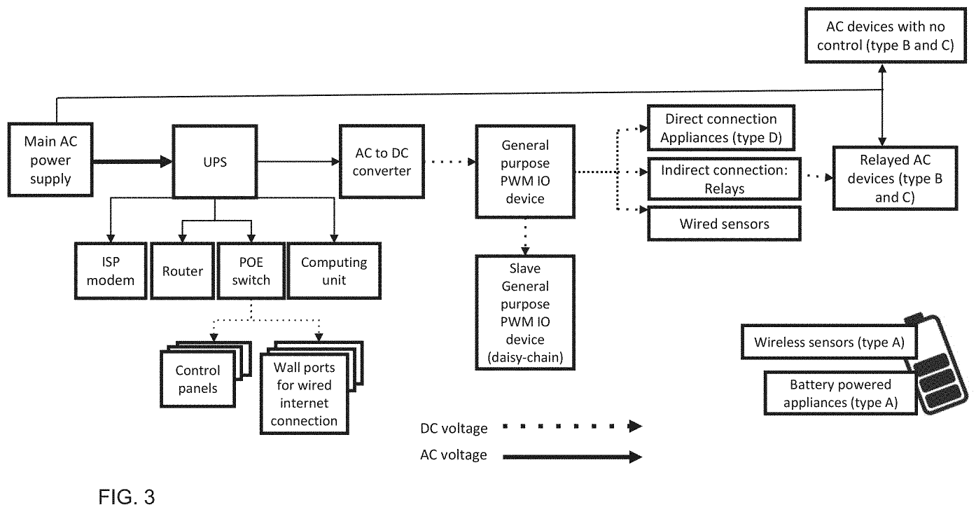

In FIG. 3, a typical electrical supply network, provided according to certain embodiments, is described. Main AC power (or solar based power, or a combination of both) may be used for legacy higher power devices, but in parallel is transformed to DC levels which are appropriate for power distribution (e.g., 24V/48V), and both are used to feed different appliances according to their respective needs. The DC based powered devices are fed through a typically general purpose PWM/IO (Pulse Width Modulated-Input/output) network, which provides either direct connections or relayed connections. E.g. as indicated in FIG. 3, while some AC devices are fed directly with no apparent control (besides energy measurement etc.), other AC devices are conditionally operated by a relayed connection—meaning that their power source is connected or disconnected by a relay controlled by the PWM/IO (Pulse-width modulation input/output) network.

Other infrastructure supporting devices such as sensors (to be monitored by the system health monitoring functions) may be also fed by the DC network.

The non-bold lines in FIG. 3 may comprise energy supply paths or channels. For example, x may supply energy to Y which, say, converts that energy to something else, such as AC voltage (220V) to DC voltage (48V) to Pulsed Width Modulated Voltage (on/off), or to lower DC voltage (5V) etc. etc. and, say, supplies it to Z etc.

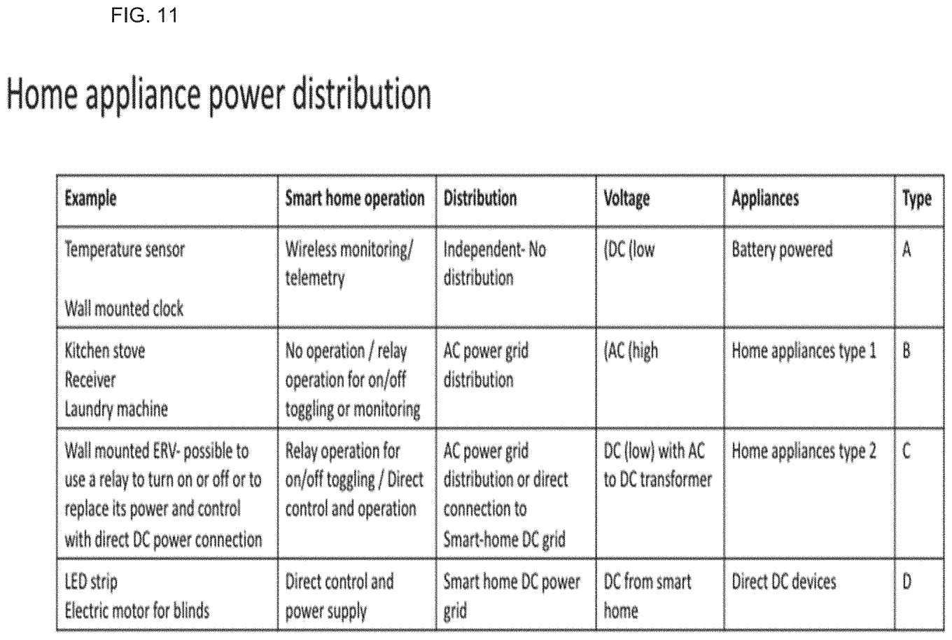

Types A-D mentioned in FIG. 3, are intended to be understood in accordance with the table of FIG. 11. As shown, type A appliances are battery powered, whereas type D appliances are direct-DC devices such as an “LED strip” light fixture or motor for shutters or blinds. The voltage of each type of appliance differs as shown in the voltage column in FIG. 11. The term ERV in type C refers to Energy Recovery Ventilators. The 2^{nd} column presents the low level operation that the device supports. The 3^{rd} column determines whether there are any specific yet high level power requirements with more details in the fourth column. For example, a sensor (the first device listed) has a low level function of providing measurements (telemetry), but has no power requirements from the system, since the sensor works on a battery. It is also indicated that the sensor requires low voltage DC.

The term ‘RECEIVER”, in FIG. 2, is intended to include stove ventilators and ventilated oven hoods:

### EXAMPLE

According to certain embodiments, a layer (e.g., device abstraction and/or infrastructure) may determine which width of pulses to supply to a given appliance as a function of a user's command to the appliance. A power line may be providing 12V on a constant basis to certain appliances, however, the device intelligence layer may effectively cause the power line to provide higher or lower levels of wattage to certain appliances, depending on a user's command given, via the appliance layer, to the appliance. For example, if a dimmable LED is commanded by an end-user, via the application layer, to achieve 70% dimming i.e., illumination with very low brightness, short pulses may be employed to enable the power line to provide, effectively, lower wattage to the dimmable LED. Conversely, if the dimmable LED is subsequently commanded by the end-user, via the application layer, to achieve 30% dimming, i.e., illumination with fairly high brightness, longer pulses may be employed to enable the power line to provide, effectively, higher wattage to the dimmable LED. Similarly, if an HVAC device is commanded by an end-user, via the application layer, to operate in low-intensity mode, short pulses may be employed to enable the power line to provide, effectively, lower wattage to the HVAC. Conversely, if the HVAC is subsequently commanded by the end-user, via the application layer, to revert to a high-intensity heating (say) mode, longer pulses may be employed to enable the power line to support the high-intensity heating.

According to certain embodiments, the control panels of FIG. 3 may comprise any suitable Smart Home Control Panel, typically pre-installed e.g., by manufacturing in the factory, then plugged in onsite. The panel typically enables an end-user to access smart home functions via touches, clicks, taps, or any other user motion.

According to certain embodiments, as opposed to conventional smart homes in which each smart home owner has to configure his own home each winter and each summer, which is inconvenient, the methods herein allow for an application layer which may include a maintenance department managers' user interface which enables a manager to introduce project-wide configurations e.g. each winter, increase target temperature in all north-facing bedrooms in all buildings in the project by 4 degrees, and increase target temperature in all south-facing bedrooms in all buildings in the project by 2 degrees.

Due to the ease by which this is done, more sophisticated configurations may be introduced e.g. set target temperature differently for north- and south-facing bedroom as above, but do so incrementally as summer recedes into winter, e.g. as a function of weather in the project's geographical area.

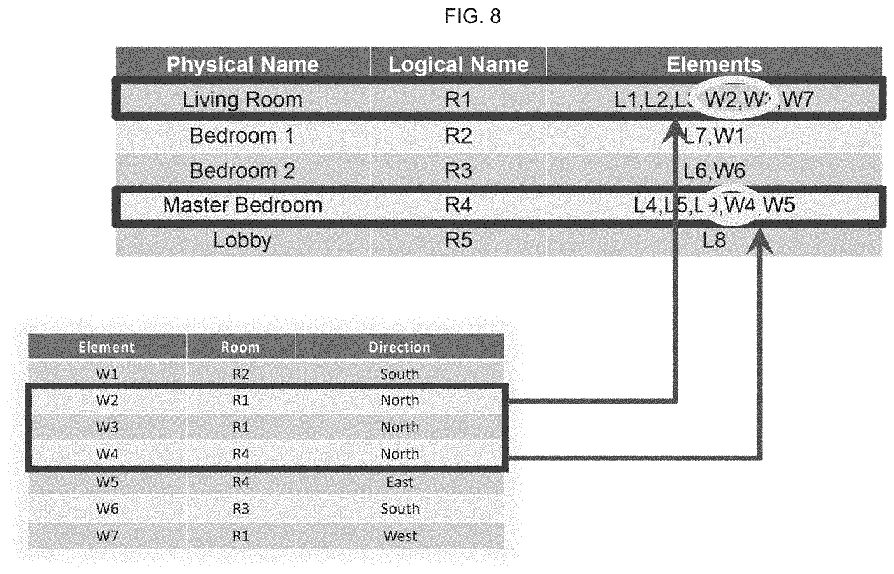

Thus, especially given meta-application layer interfaces, e.g. as shown in FIG. 8, the application layer may include at least one Tech App which may he accessed only by technicians and/or may include a User app which typically has much more limited settings and supports only basic control required for normal operations.

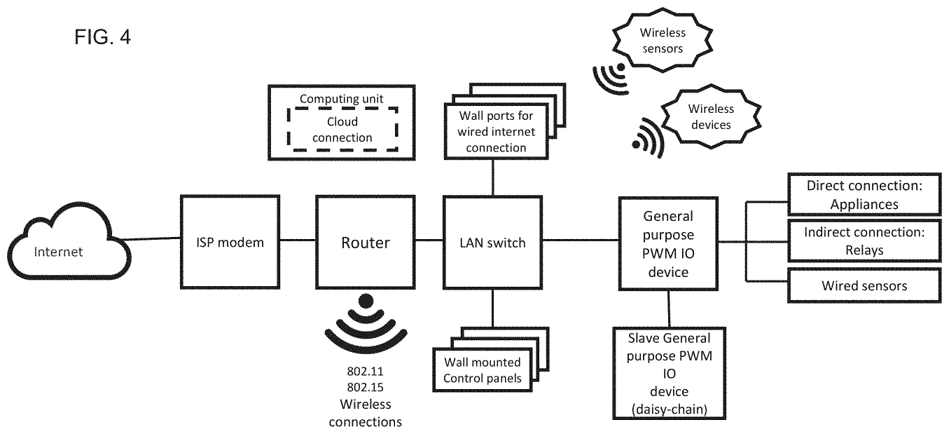

In FIG. 4, a typical implementation of a communications network useful in accordance with certain embodiments, is described; all or any subset of the illustrated blocks may be provided. The network is connected to the Internet via an ISP modern (e.g., cable, DSL, fiber). The main backbone may, for example, be Ethernet, which typically uses routers (e.g., with WiFi) and/or LAN switches. Other wireless technologies such as Bluetooth and ZigBee are interfaced to this network and cover all different appliances and sensors within. The general purpose PWM (Pulse Width Modulated) and IO (input-output) devices which are part of the electrical distribution network, are also controlled and monitored by the communications network.

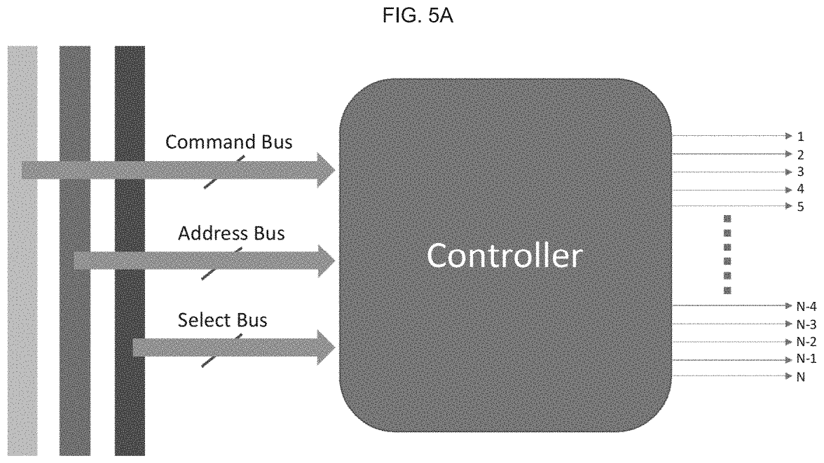

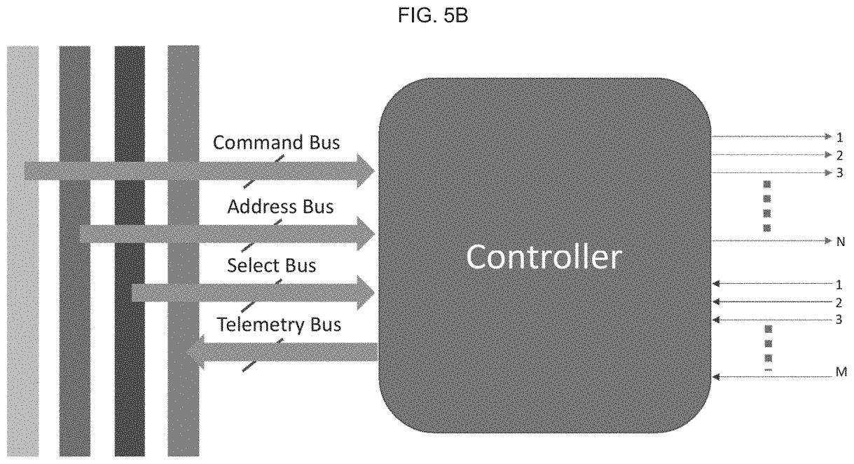

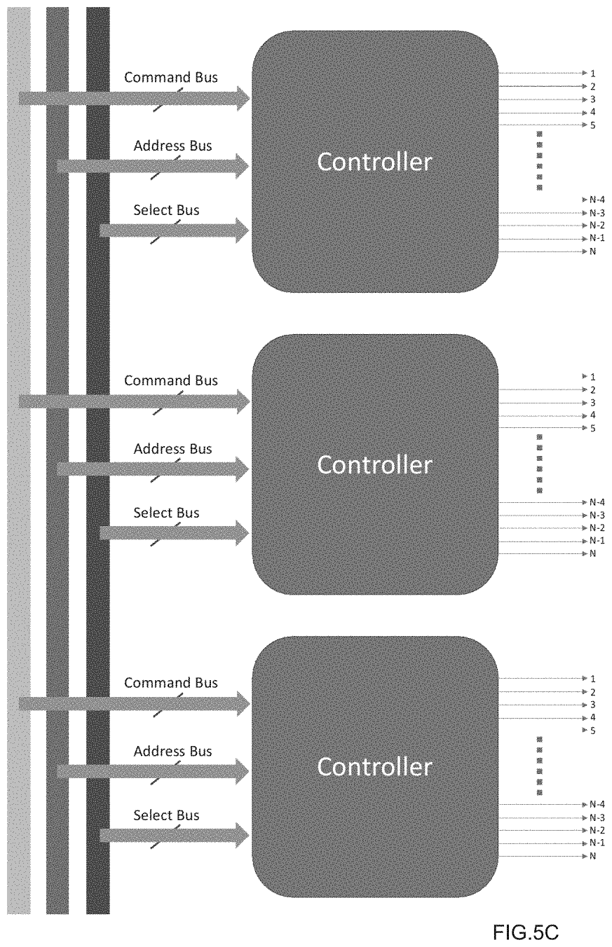

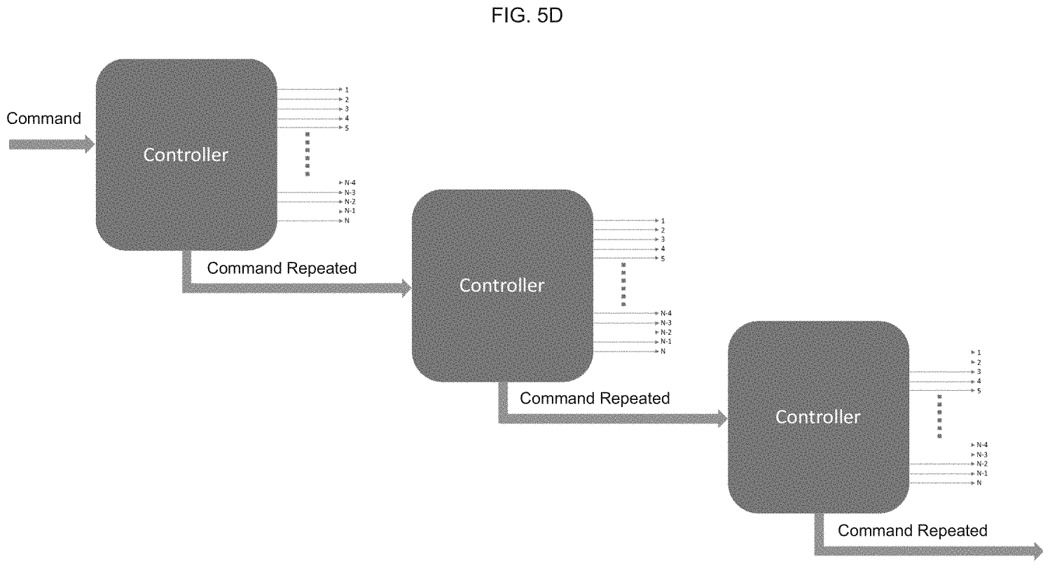

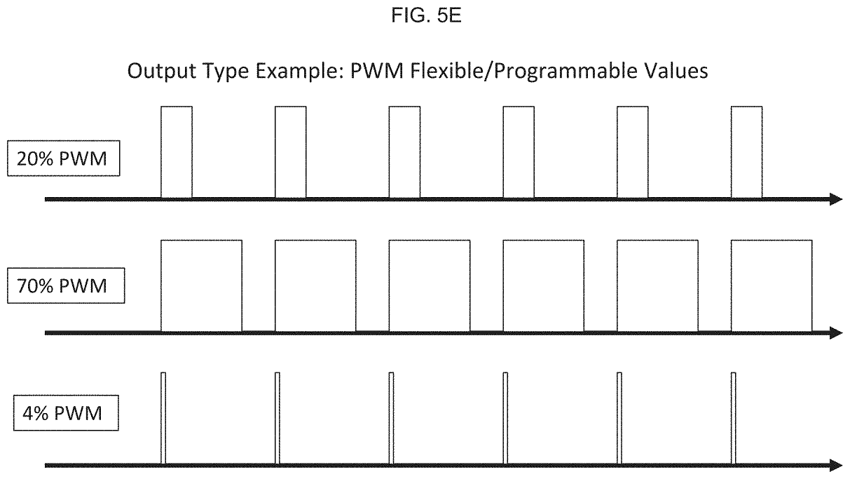

The device abstraction layer, is, according to certain embodiments, focused on device connectivity e.g., which appliance/s are connected to which controllers. In FIG. 5A, a general purpose PWM IO (Pulse Width Modulated-input/output) is presented. At its core, the controller is interfaced through some communication channels. In FIG. 5A a multiple bus arrangement is presented which may include all or any subset of:
An address bus which is used e.g., by or in the device abstraction layer, to select a specific connected appliance, from among those smart home appliances controlled by this controller, through the controller itself
A command bus which is used to send commands to the controller
A select bus to select a specific controller when more than one controller exists
It is appreciated that any bus may select one of the plural outputs 1, 2, . . . n−2, n−1, n of the controller.

According to certain embodiments, the command bus may also supply energy.

Other communication formats which may provide similar functionalities are also possible (e.g., serial interface).

In FIG. 5B, an additional telemetry bus may be provided in the infrastructure layer, for bi-directional communications, e.g., to enable situational data to be collected from sensors deployed in a room. This facilitates the possibility of querying the controller itself (e.g., FIG. 1 elements 108/109) regarding its status, or for retrieving information from the connected devices themselves (e.g., sensors), for example, if one of the infrastructure components fails, or one or more of its communication/power ports fail. Other options for such communication abilities are possible (e.g., serial) e.g., as described above.

When more than one controller is provided, the system, according to certain embodiments, provides plural possibilities for connectivity. In FIG. 5C, plural controllers are sharing the same bus architecture, hence they are exposed to the data and signals communicating with them. It is appreciated that the embodiment of FIG. 5c supports additions of new controllers with minimal impact on other controllers, as opposed to a conventional serial connection in which one failure may completely disconnect all network components. In FIG. 5D, an architecture is demonstrated in which at least the command bus information is repeated in a daisy chain topology (e.g., wired together in a sequence or ring), meaning that while the command bus feeds a certain controller, the electrical signals and or the relevant data of the command, is/are repeated and sent to another controller. This is typically useful when the physical propagation characteristics may reduce the signal level for long distance communications.

In addition, the arrangement of controllers may include various operation redundancy schemes, typically implemented in the infrastructure layer; see e.g. FIG. 1 at elements 108/109, for increased operational reliability, such as but not limited to:
1. Duplicating some or all of the controllers for stand-by purposes if one or more controllers fail to operate. For example, the system health monitoring (109 in FIG. 1) senses an operational problem such as, say, port output failure, associated with one of the controllers, and turns on the standby controller (including disconnecting and turning off the problematic controller); and/or
2. Arranging for dynamic master-slave allocations, typically system-wide and not specific to to any specific appliance. For example, in FIG. 5C, one of the controllers may be assigned as a master unit (e.g., centralizing control) while others are “slaved” to the master unit, yet in case of communication errors or any other operational failure preventing the master unit from operating properly, a new master assignment takes place, in which a standby controller is designated to act as master unit to which the inoperative master unit is disconnected.
   Typically, in a master-slave(s) situation, the intention is to operate the full network infrastructure through one device (aka master) which controls all other “slaved” controllers. The master may act as a center-point, e.g., receiving all communications from all slaved devices, and/or may perform additional functions e.g., performing network integrity check-ups typically by querying other controllers about their status and assessing their responses. Responsive to replies to these queries, the master may update the network configuration accordingly. For example, if controller X has a failure on its ports, and instead of 16 ports, only 14 are operational, the master may update the system resource management database to avoid future assignment of these ports. In parallel, an error notification by the master may be sent for possible component replacement.

From the perspective of the device abstraction layer provided in accordance with certain embodiments, a device is interfaced through such controllers and is assigned a specific identifier (e.g., an address). In addition, specific ports are also assigned to the device for power supply and communication needs. This layer is typically not aware of the exact device logic or device behavior which may be required for proper information. For example, a bathroom ventilation device for fresh air, from an abstraction layer perspective, may focus on its connectivity to a power source, and if the fan speed may be controlled or not. On the other hand, if it is necessary to turn on or turn off the fan, under certain conditions which relate to its intrinsic behavior (e.g., power off after some time limit) this may be reflected in or performed in or handled by the device intelligence layer and/or in other higher layers e.g., if this specific operation is related to some operational scenario.

In FIG. 5E, an output port which is connected to a device for the purpose of power supply, is pulse width modulated for reducing or increasing the power level delivery. A dimmable lighting device, or a speed-controlled fan, may be able to vary their operation conditions as a function of the pulse width. Turning off the device may reduce the pulse width duty cycle to 0, while full power is delivered with 100% duty cycle.

It is appreciated that the specific smart home control systems shown in FIGS. 5a-5e are merely exemplary, and are not intended to be limiting.

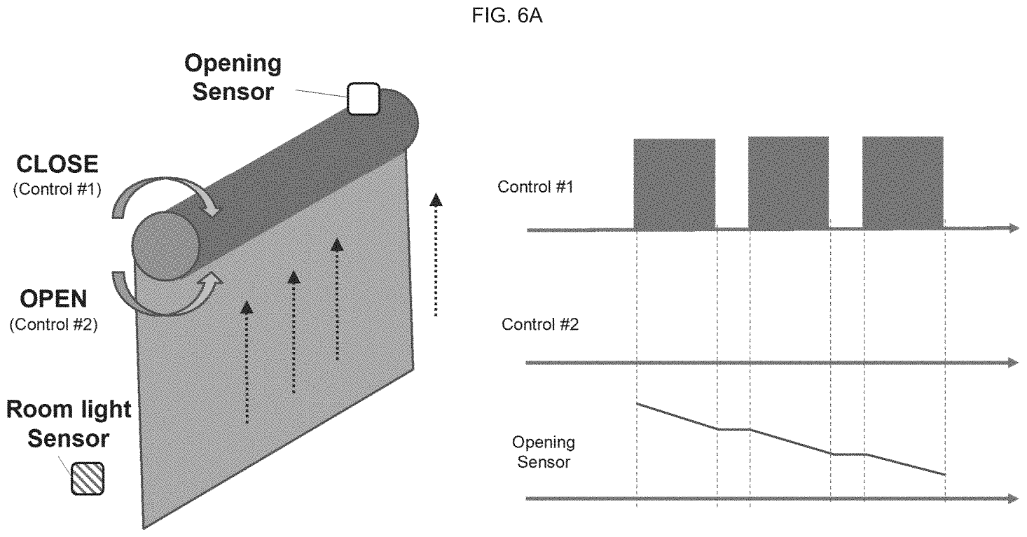

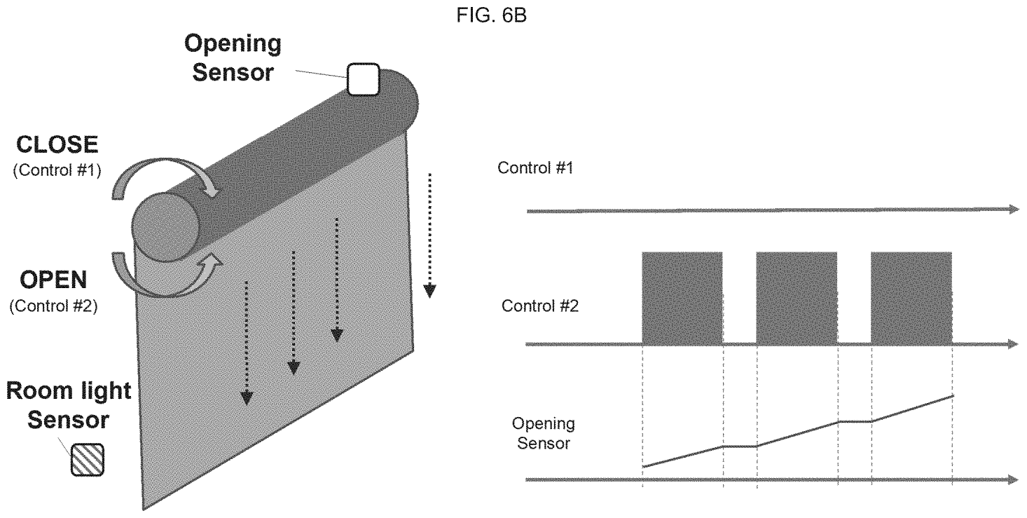

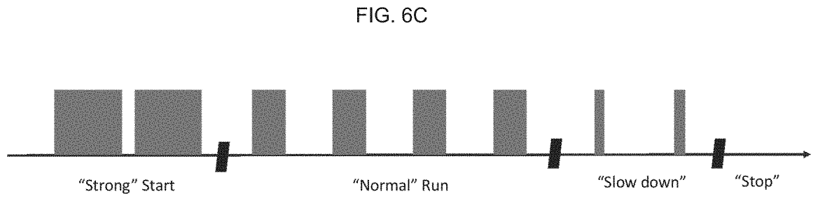

The device intelligence layer provided in accordance with certain embodiments, e.g., as described above, may provide the useful function or main functionality of the device. For example, consider a window shading device (FIG. 6A close shade, FIG. 6B open shade) which may be controlled to roll open or roll close its shade.

From the device abstraction layer perspective, a device e.g., the window shading device in the present example may have two controls which are respectively used to operate the motor (rolling the shade) in either direction.

For example, control #1 is used for rolling the shade up, while control #2 is used for rolling the shade down. More precisely, control #1 is actually an output port of a controller, which, each time the voltage level is “on”, causes the motor to operate in a certain direction, while control #2 is actually an output port of a controller, which, each time the voltage level is “on”, causes the motor to operate in the opposite direction. Using a pulse width modulated scheme on either port may decrease or increase the speed at the motor may operate. In addition, sensor/s (e.g., light sensor sensing ambient light and/or opening sensors) may be in data communication with the controller and may be deployed to monitor operation of the device e.g., to report back the. status of the amount of shade opening. From the device abstraction layer perspective, “no shade” or “full shade” or “partial shade” is meaningless as the device abstraction layer is completely unaware of the desired functionality of such a device. Even the sensor result is just a numerical figure which is read, e.g., by the device abstraction layer, directly from the window shading device, without the device abstraction layer understanding the sensor result's true meaning. According to certain embodiments, the sensor result is passed from the device abstraction layer to the device intelligence layer which does understand the true meaning of the sensor reading e.g., understands that a light sensor reading of 0% means that a given window shade is completely closed, whereas a reading of 100% means the shade is completely open. Alternatively, or in addition, other sensors may be installed nearby (a room light sensor), which are not an integral part of the shading device, at least from the device abstraction layer perspective, yet may be required for complex operational scenarios as perceived by the device intelligence layer (e.g., indirect feedback that the shading operation took place and was effective).

The device intelligence layer is typically configured to facilitate the function of the shading device and how it is considered with respect to operational limitations. For example, all or any subset of the following features may be provided:
The meaning of “reduce amount of shading” is translated to signaling on control #1
The meaning of “increase amount of shading” is translated to signaling on control #2
Sensor (e.g., Photoelectric Device or other light sensor) reports percentage of shading (typically calibrated to convert amount of light to % of shading e.g., from 0%—no shade, 100%—full shade)
For a target shading setting, the motor should advance slowly when reaching the target for avoiding sudden torque changes
For a target shading setting, the motor should start at full force for maximum torque

As described in FIG. 6C, the signal level at either control #1 or control #2 (depending on whether the shade is to be further opened or further closed) is changed according to the operation conditions. A strong start, e.g. with high moment, is indicated by wider pulses with a higher duty cycle, while subsequently, during normal run, slower or weaker operation, e.g. with lower moment, is indicated and achieved by narrower pulses which may have a lower duty cycle, since once initial inertia has been overcome with the initial high-moment or high-duty cycle operation, a lower duty cycle may be preferable, since it is not desirable for the shades to open (say) too quickly. Even slower, weaker operation, e.g., with even narrower pulses, may be used further on e.g., to enable better control of when exactly to stop to prevent slamming of the shutter against the window-frame. In a final phase of operation, the shutter stops (no pulses) The complete logic of determining which control port to use, and the exact schedule of the pulses, is determined by the device intelligence layer.

According to certain embodiments, the application layer, for example, is entirely unaware of what voltage is to be supplied to a given appliance, at which point of time, e.g., since this is the purview of the device intelligence layer. And/or, the application layer may be entirely unaware of the home layout e.g., of which shutters are deployed on north-facing windows, since this is the purview of the home intelligence layer. Typically, the actual wiring, in the infrastructure layer, is also entirely transparent to the application layer.

For example, all or any subset of the following operations may be performed e.g., by the device intelligence layer; the operations may be performed in any suitable order e.g., as follows:
Receive shading instruction S
Read current shading condition C
Is target shading greater than current condition S>C? If yes use control #2 otherwise use control #1.
Compute Q=|S−C|
Is Q below nearby conditions (meaning that the new setting is within the vicinity of the current shading status and the motor should not operate at full capacity)? If yes, then use low duty cycle settings (D=D1) until target reached, otherwise operate as follows
Create activation plan based on Q
   set “strong start” period (based on 10% of Q, meaning that full torque is applied for a small gap of the difference)
   set “normal run” period (based on 80% of Q)
   set “slow down” period (based on 10% of Q, meaning that low torque is applied while reaching target)
Activate plan until target reached
Utilize other sensors to feed back shading change (e.g., external light sensor)

So, typically, all or any subset of the following features is provided:
Any new device added to the system (e.g., the smart home owner purchases and deploys a new stove or clock) is acknowledged by the device abstraction layer and/or by the device intelligence layer, typically by both.
The device abstraction layer handles and registers the core connectivity and energetics (power supply) of the device e.g., how many ports are used to control, power supply features (AC, AC controlled, DC), telemetry ports etc. The resource management function handles the allocation of required resources.
The device intelligence layer respects and registers any required functionality of the device, presenting to the system and to the end-user (via the appliance layer) each device's or appliance's true purpose, and not the lower layer operational aspects which are insignificant from an end-user perspective. The logic or software which is used for establishing such functionality is handled by this layer.
The device intelligence layer may utilize a number of non-integrated devices for facilitating a certain function (e.g., a sensor which is external to a given appliance, but senses a parameter which is affected by the appliance e.g., a thermostat or humidity sensor which may be used to facilitate operation of an HVAC device, or similarly with the example of the window shading device and another e.g., external light sensor)

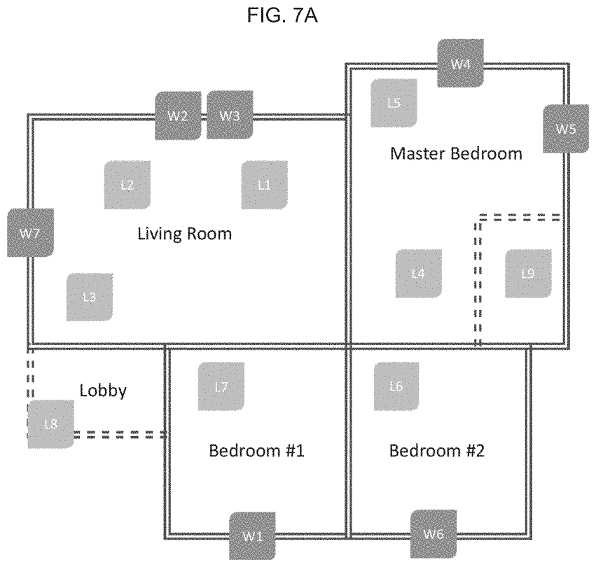

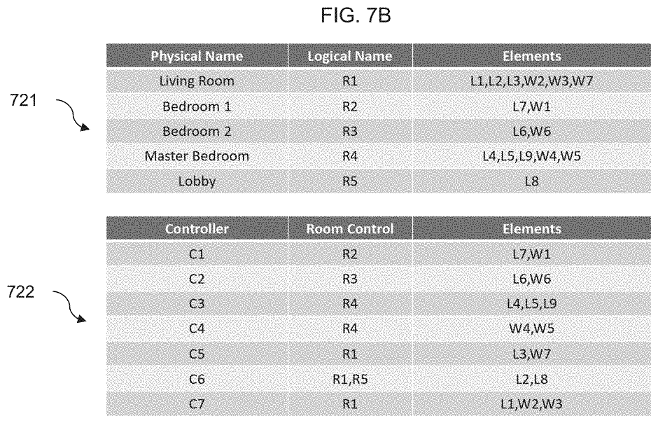

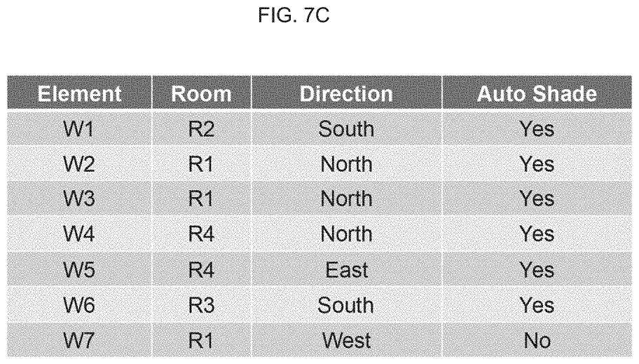

According to certain embodiments, the home intelligence layer, e.g., as described above, integrates the use of all the devices within the house (or apartment) and provides geographical related associations (e.g., bedroom, kitchen) which are necessary for establishing daily routine scenarios. FIG. 7A provides an example of a deployment which demonstrates the home intelligence layer operation. For example, the “Master Bedroom” area is shown to have plural associated devices deployed therewithin; W4, W5 are window shading devices, while L4, L5 and L9 are light fixtures. “Bedroom #1” area has one window shading device W1 and one light fixture L7, etc.

For example, the home intelligence layer may have logic ensuring that when windows are shaded in bedroom1, then bedroom1's light fixtures go on, in at least some modes of operation (e.g., when the home is occupied and/or other than late at night). Or, the home intelligence layer may have logic ensuring that when an HVAC device in bedroom1 is turned on, the windows are closed. Or, the home intelligence layer may have logic ensuring that when an occupancy sensor in bedroom1 senses that a person has entered bedroom1, then bedroom1's HVAC devices and/or light fixtures go on, whereas each time the occupancy sensor in bedroom1 senses that a person has left bedroom1, then bedroom1's HVAC devices and/or light fixtures go off. It is appreciated that control of bedroom1's devices may only partly depend on the occupancy sensor e.g., devices may be turned off only several minutes after the person has left the room, to prevent lights going on and off each time a person wanders out of her or his room for only a few seconds.

Each appliance in a home may be characterized as having an architectural location e.g., a room within which the appliance is deployed, having a geographical location e.g., in terms of north/south/east/west, or distance from a geographical reference location, and having a network location within the electrical network of control and/or power lines.

When wiring a smart home, the electrical interconnections of the appliances may not mirror the appliances' respective architectural locations. For example, it is possible that all appliances in one room may be governed by (hence may communicate electrically with) a single “first” controller, whereas all appliances in another room may be governed by a different, “second”, controller. However, this is not necessarily the case. It is also possible that the first controller may govern operation of appliances in the bedroom and some kitchen appliances, whereas the second controller may govern operation of appliances in the living room and certain appliances in the kitchen as well. This may occur due to many different engineering considerations, such as, by way of non-limiting example, a given controller, which may be electrically connected to up to 13 appliances, and since there are only 9 appliances in the bedroom, when the home is wired, a decision is made to assign 4 appliances in the kitchen to that controller as well. The result is that the physical control map (of the wiring) of appliances in a smart home is counterintuitive, to an end-user of the smart home.

The tables (721, 722) shown in FIG. 7B are stored in the system's database after the devices have been configured e.g., as described above. The first table (721) associates the room or area name to an alphanumeric label and lists the related devices. For example, “Bedroom #1” is labeled as “R2”, whereas other rooms are labeled R1, R3 etc. In the example, light fixture L7 and window shade W1 are associated with room R2, whereas other light fixtures and window shades are not. There may be plural appliances of a given type in a given room e.g., 3 light fixtures and 3 window shades in room R1, which is the living room.

The second table (722) associates each controller with its connected devices. Sometimes, two controllers may be associated with, aka coupled with, appliances or elements or devices or fixtures (these terms may be interchanged herewithin) in a single room e.g., controllers C5 and C7 are both associated with appliances or elements in room R1. A controller may be tightly or exclusively coupled with a single room. For example, controller C6 handles lighting fixtures L2 and L8 which are located at different rooms (R1, R5). In addition, plural controllers may be associated with the same room or area, especially if the area contains a large number of devices. These tables are, e.g. as described above, either configured directly or derived during the installation or configuration phases of the system. Additional geographical related information may be stored as well for facilitating complex scenarios.

For example, the table in FIG. 7C, includes, for the window shading items, the window facing direction, as this may become useful for automating the shading process during the day. Thus the system is aware that window-shade w1 for example faces south, whereas window-shade w7 faces west.

For example, consider a scenario which calls for changing the shading of all windows facing north and updating the lighting intensity level accordingly (depending on daytime). First, the system may locate all window shades faced at that direction by using the table of FIG. 7C) and using previous tables e.g., as shown in FIG. 7B for associating the controllers and room/area.

This is demonstrated in FIG. 8. The window shading devices facing north are W2, W3 and W4. W2 & W3 are located in room R1, while W4 is located in room R4. As shown, room R1, has L1, L2 and L3 lighting fixtures, while room R4 has L4, L5 and L9 lighting fixtures. Table 722 in FIG. 7B associates the relevant controllers for addressing both relevant shading devices and lighting fixtures. For example, room R4 which contains W3 & W4, which are managed by C4, yet the lighting fixtures of R4 (which are L4, L5, L9) are managed all by C3.

All or any subset of the following advantages may characterize the system shown and described herein:
Using the various configuration tables stored for the home intelligence layer, complex operating scenarios are easily supported.
These configuration tables are established as the devices are being configured or installed.
The tables reside in the system's database.
The associations are generated through resource management operation when devices are abstracted.
The device intelligence layer may add additional information relevant for high level functionality of the device, For example, if geographical related input is relevant, then the associated tables may include this information and it may be required to be input as part of the installation/configuration.

According to certain embodiments, the system provides, in the abstraction layer, a single protocol between controller and appliance which, rather than only turning the appliance on and off, instead additionally receives sensed parameters from the appliance.

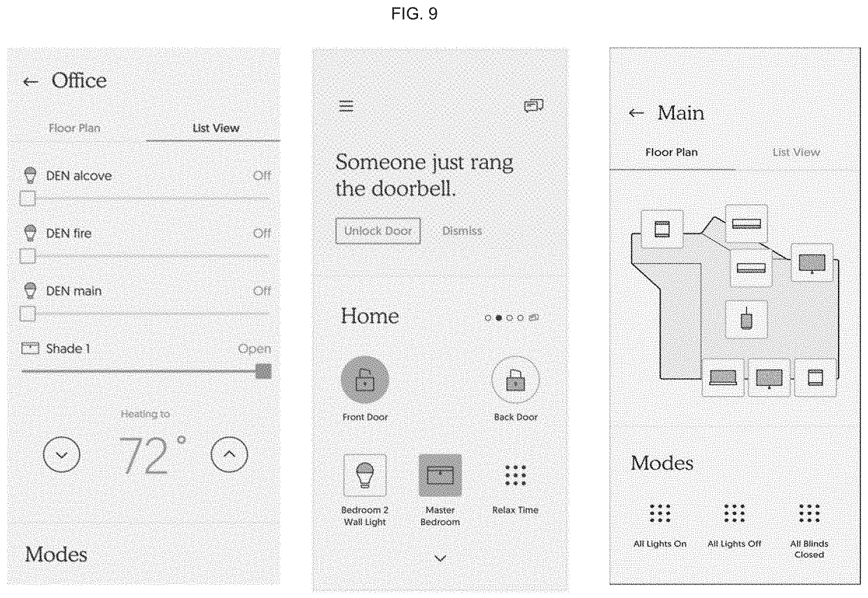

The application layer, according to certain embodiments, includes software infrastructure or logic for establishing end-user applications and/or configuration and management applications. The application layer typically allows for an app to interface to the lower layers of the system and to associated data, depending on target functionality. For example, in FIG. 9, a couple of example screenshots of such applications are shown; all or any subset of the elements shown in each screenshot may be provided in practice. One application (screenshot on the right in FIG. 9) facilitates the grouping of various devices in order to establish an overall rule (e.g., “all lights on/off”), or may indicate certain status of operation of these devices. The middle screenshot in FIG. 9 demonstrates additional capability to monitor and answer doorbell calls, while the left screenshot demonstrates additional fine-tune control of certain devices within a certain area.

It is appreciated that any user, whether layman or technical department, may define these groups of appliances.

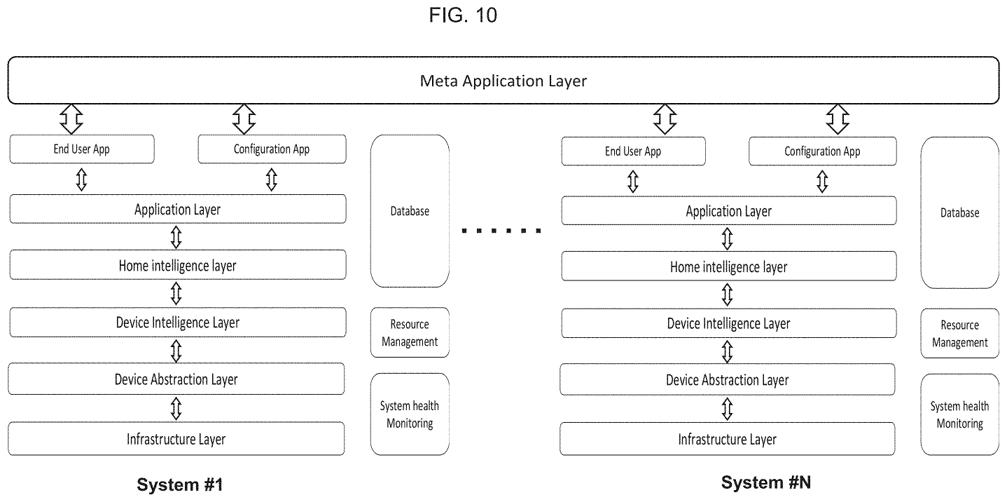

In some embodiments, more than one system exists which may require some harmonized control. For example, a property management company may handle plural buildings in a certain area, with multiple apartments per building. In this case, the system facilitates multiple sub-system control, e.g. as demonstrated in FIG. 10.

According to certain embodiments, when a new building project is populated and/or when a new device (say, new BOSCH fan model HG276A is about to be introduced by all or some project tenants to replace currently installed older models, the project's maintenance and installation department may program the new device's characteristics into the system (e.g., a table entry, software module). Each appliance's characteristics may for example include energy requirements and/or control options and/or whether there is a specific protocol to communicate with the device. The system then translates these characteristics into, say, the number of ports required by each new fan (e.g. one port for relay control of AC 220V supply, another port for control with a software module providing interaction with the fan, and a third port for receiving data/telemetry from the fan; totaling 3 ports required.

A meta-application layer interfaces, e.g., as shown in FIG. 8, with plural sub systems (e.g., N apartments in a single building and/or M buildings in a single complex and/or C complexes in a single smart city), typically through their own dedicated application layers. This facilitates various use cases and scenarios, but is not limited to:
Common configurations—for example, configuring similar applications with similar functionalities, scenarios, and features
Common actions—performing system wide operations such as turning on all emergency lights at designated areas within each apartment
Common resource management—in many cases, apartments share a common area, common resource elements (e.g., solar panels on the roof of a building shared by multiple apartments), or even common waste systems. This is enabled by the fact that each sub-system is able to control and measure (sense) devices within its own designated area (region).

For example, the provision and/or billing of electricity and water may be simplified. In many cases, resources are supplied and/or billed as a whole by the governing agency (e.g., one utilities e.g. electricity bill for an entire complex or building):
1. By monitoring each apartment (say), their relative use may be measured and may be billed accordingly, e.g. while the billing provisions of a building are done based on the total consumption C of a resource, C is the sum of plural units—apartments Ai and public areas Pj—hence C=A1+A2+ . . . +P1+P2+ . . . and as each unit's relative use may be measured, the corresponding billing of any unit may be derived.
2. In addition, the billing structure may be modified and enhanced for each apartment by, for example, offering discounts if energy is wasted only during off-peak hours and not in peak hours, etc. For example, to continue the previous example, the consumption of 2 units is measured as a function of time T, C(T)=A1(T)+A2(T) and the billing of the first unit may be B(T, A1(T)) and the second unit may be B(T, A2(T)) where B(t,v) is a billing function which depends on the time of day “t” and the instantaneous consumption “v”, thereby, say, to incentivize unit-owners to use high-energy appliances during low-demand hours of the day.
3. In the case where the control units or additional sensors are aware of appliance consumption (e.g., water, electricity), this information may be used for monitoring purposes (e.g., through a dedicated end-user application) and/or for optimization purposes e.g., if energy storage is involved (e.g., solar panels). In the case of optimization, scenarios of scheduling operation of any complexity may be deployed including prioritization of consumption. For example, electrical car charging may be postponed to or scheduled during off-peak e.g., night hours. Also, it is sometimes the case that an appliance used in common by plural unit-owners e.g., an electric car charging station may only be added retroactively by using the power supply of a given unit, rather than the power supply for common areas. When this occurs, monitoring may be used to subtract the electricity usage of this commonly used appliance from the individual electric bill of the specific unit whose power supply was exploited.

Another advantage of embodiments herein vis a vis typical conventional smart homes is that providers of conventional smart homes typically fail to appreciate the possibility of and the advantage of designing a home in advance to be smart, e.g. using any of the methods and systems described herein, and, instead, continue to implicitly assume that providing a smart home involves converting a non-smart home, with already designed electrical/communication infrastructure, ex post facto, into a smart home. The conventional smart home is typically an add-on capability supported by an existing electrical/communication infrastructure which was not designed, e.g., using any of the methods and systems described herein, to support smart home functionality. Conventionally, when converting a non-smart home to a smart home, no modifications are typically made to the existing electrical/communication infrastructure e.g., to any existing outlets etc.

To achieve workable smart homes for average people, certain embodiments herein teach methods for providing smart homes by prefabricating homes e.g. by performing all or any subset of: (a) mass customization which employs 3D design tools and/or known Veev construction methods, and using any embodiment herewithin, to yield homes (e.g. a condominium, mass-customized building project including plural buildings, or smart city) equipped with efficiently controlled mutually compatible appliances, some or all of which may be built-in, (b) preliminary central configuration of entire sets of homes so prefabricated using algorithms which typically take into account all or any subset of home-owner parameters, such as number of occupants or their age, geographical parameters such as each home's direction, and design parameters, such as which options each home-owner selected for her or his mass-customized home, to yield smart home configurations which serve occupants well, even if the occupants are unable or unwilling to individually configure their own homes, (c) ongoing central configuration of entire sets of homes using algorithms which typically take into account changes in any of the above parameters, such as new occupants or new weather conditions, and/or (d) machine learning to improve the algorithms including collecting data indicative of home-owners' level of satisfaction with the configurations generated by the algorithms e.g. home-owners attempts to reconfigure manually and/or home owners' appeals to the project's or smart city's technical personnel to reconfigure appliances. While, ostensibly, providing smart homes by building new homes, rather than by adding smart capabilities to existing homes, seems impractical, in fact the opposite is the case. First, existing homes age and become unsafe, such that building new homes is inevitable in any case. Also, increased crowding worldwide requires new taller buildings to replace old, space-wasting buildings in any event, again implying that building new homes is inevitable in any case. Finally, building new homes is becoming far more cost-effective than new construction was in the past, e.g., thanks to Veev building technology inter alia.

According to certain embodiments, electrical/communication infrastructure provided according to embodiments herein is at least partly deployed behind a drop ceiling or stretch ceiling which provides easy access to plumbing, wiring, and ducts, e.g., between the stretch ceiling and the structural ceiling above the stretch ceiling.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer usable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service, or any other information described herein that impacts, in a positive manner, a problem or objectives described herein; and (b) outputting the solution.

The system may, if desired, be implemented as a network—e.g., web-based system employing software, computers, routers and telecommunications equipment, as appropriate.

Any suitable deployment may be employed to provide functionalities e.g., software functionalities shown and described herein. For example, a server may store certain applications, for download to clients, which are executed at the client side, the server side serving only as a storehouse. Any or all functionalities e.g., software functionalities shown and described herein may be deployed in a cloud environment. Clients e.g., mobile communication devices such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware, or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous, given the state or condition or data. Alternatively, or in addition, an alert may be provided to an appropriate human operator or to an appropriate external system.

Features of the present invention, including operations, which are described in the context of separate embodiments may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment, or in a certain order, may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g., as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof may also be provided as methods and operations therewithin, and functionalities described or illustrated as methods and operations therewithin may also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via WiFi, Bluetooth, or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop, or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include apparatus whether hardware, firmware, or software which is configured to perform, enable, or facilitate that operation, or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry, including any such computer microprocessor/s, as well as in firmware or in hardware, or any combination thereof.

It is appreciated that elements illustrated in more than one drawing, and/or elements in the written description, may still be combined into a single embodiment, except if otherwise specifically clarified herewithin. Any of the systems shown and described herein may be used to implement, or may be combined with, any of the operations or methods shown and described herein.

It is appreciated that any features, properties, logic, modules, blocks, operations or functionalities described herein, which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations, or functionalities described herein, which are, for brevity, described in the context of a single embodiment, may also be provided separately or in any suitable sub-combination, including with features known in the art. Each element, e.g., operation described herein, may have all characteristics and attributes described or illustrated herein, or, according to other embodiments, may have any subset of the characteristics or attributes described herein.

It is appreciated that apps referred to herein may include a cell app, mobile app, computer app, or any other application software. Any application may be bundled with a computer and its system software or published separately. The term “phone” and similar used herein is not intended to be limiting, and may be replaced or augmented by any device having a processor, such as but not limited to a mobile telephone, or also a set-top-box, TV, remote desktop computer, game console, tablet, mobile e.g. laptop, or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node). Thus, the computing device may even be disconnected from e.g., WiFi, Bluetooth, etc., but may be tethered, directly or ultimately, to a networked device.

1. A smart home system comprising:
a data repository defining categories or groupings of smart home appliances or devices, and storing, for each individual appliance, an indication of a controller which governs the individual appliance;
a user interface (presenting a menu of said categories) enabling a smart home end-user to enter a selection of a command and an individual category from among said categories to which the command is to be applied; and
a hardware processor which, responsive to said selection, retrieves from the data repository the indication of the controller which governs each appliance in said individual category, thereby to define a set of controllers to which the command is to be communicated, and communicates the command to all controllers in said set.

2. A system according to claim 1 wherein said data repository comprises at least one relational database thereby to support plural orthogonal groupings of the appliances.

3. A system according to claim 2 wherein the plural groupings are along at least one of the following dimensions: functionality of the appliance, architectural unit in which the appliance is deployed (room, living unit, story/floor, building), geographical location of the appliance, or physical characteristics of the appliance such as energy requirements or appliance age.

4. A system according to claim 1. wherein said data repository comprises tables storing groupings of appliances and indications of which controllers govern which appliances.

5. A system according to claim 1 wherein said categories includes a first category of appliances facing in a first geographical direction and a second category of appliances facing in a second geographical direction.

6. A system according to claim 1 wherein said appliances comprise at least one of window shades, light fixtures, or HVAC devices.

7. A system according to claim 1 wherein said categories include a first category of appliances deployed in a first room, and a second category of appliances deployed in a second room.

8. A system according to claim 1 wherein said categories include a first category of appliances deployed on a first floor, or story or level, and a second category of appliances deployed in a second floor, or story, or level.

9. A system according to claim 1 wherein said categories include a first category of appliances having a first functionality such as HVAC devices, and a second category of appliances having a second functionality, such as light fixtures.

10. A system according to claim 1 wherein said smart home appliances serve a condominium, including plural living units, and wherein said categories include a first category of appliances deployed in a first subset of the plural living units, and a second category of appliances deployed in a second subset of the plural living units.

11. A system according to claim 1 and also comprising wireless communication functionality to enable the end-user to enter said selection from a remote location.

12. A smart house system comprising:
an infrastructure layer including a physical network which provides communication with, and power distribution to, appliances, the physical network including controllers which give commands, aka control signals, to appliances, aka devices;
an application layer above the infrastructure layer which provides protocols that allow end-user software to send data, to at least one layer below, and to receive data, from the at least one layer below, and to present the data so received to end-users;
a home intelligence layer below the application layer which communicates commands, selected by end-users, to controllers which govern the appliances; and
at least one device layer, between the home intelligence layer and the infrastructure layer, which generates interpretations of commands communicated by the home intelligence layer, and wherein the interpretations depend on at least one device parameter.

13. A system according to claim 12 wherein data sent down from the application layer is at end-user level, such as “no shading”, “partial shading”, or “full shading”, and wherein the at least one device layer translates the data at end-user level to data understandable by at least one appliance.

14. A system according to claim 12 wherein at least one device layer translates data at end-user level to commands directed to specific controller output ports which cause at least one appliance motor to operate in specific respective modes.

15. A system according to claim 12 wherein hardware and/or software in each individual layer communicate with hardware and/or software in adjacent layers just below or just above the individual layer, thereby to define a stack of layers.

16. A system according to claim 15 wherein hardware and/or software in each individual layer communicate only with the hardware or software in adjacent layers just below and/or just above the individual layer, and do not communicate with hardware and with software which are deployed in non-adjacent layers, which are not just below the individual layer, and are not just above the individual layer.

17. A system according to claim 12 wherein each layer comprises logic implemented in hardware and/or firmware and/or software.

18. A system according to claim 12 wherein the home intelligence layer comprises:
a data repository defining categories or groupings of smart home appliances or devices, and storing, for each individual appliance, an indication of a controller which governs the individual appliance;
a user interface (presenting a menu of said categories) enabling a smart home end-user to enter a selection of a command and an individual category from among said categories to which the command is to be applied; and
a processor which, responsive to said selection, retrieves from the data repository the indication of the controller which governs each appliance in said individual category, thereby to define a set of controllers to which the command is to be communicated, and communicates the command to all controllers in said set.

19. A system according to claim 12 wherein the at least one device layer includes a device intelligence layer and a device abstraction layer just below the device intelligence layer,
wherein the device intelligence layer defines appliance settings which configure the appliance's ability to serve the end-user.

20. A system according to claim 12 wherein the device abstraction layer defines power and control parameters which govern supply of power to, and control of, the appliances.
